(19) United States
(12) Patent Application Publication
(10) Pub. No.: US 2009/0181302 A1
(43) Pub. Date: Jul. 16, 2009

(54) ELECTROLYTE ADDITIVE FOR PERFORMANCE STABILITY OF BATTERIES

(75) Inventors: Kaimin Chen, New Brighton, MN (US); Craig L. Schmidt, Eagan, MN (US); Donald R. Merritt, Brooklyn Center, MN (US)

Correspondence Address: MUETING, RAASCH & GEBHARDT, P.A., P.O. BOX 581336, MINNEAPOLIS, MN, 55458-1336, US

(73) Assignee: Medtronic, Inc., Minneapolis, MN (US)

(21) Appl. No.: 12/412,595

(22) Filed: Mar. 27, 2009

Related U.S. Application Data
(62) Division of application No. 11/343,323, filed on Jan. 31, 2006.

(51) Int. Cl. H01M 10/26; H01M 6/04

(52) U.S. Cl. 429/207; 429/188

(57) ABSTRACT

An organic additive to an electrolyte for a battery cell in an implantable medical device is presented. At least one organic additive is selected from a group comprising one of lithium salicylate, hydroxyphthalic anhydride, a hydroxybenzoic acid, salicylate ester, salicylamide, and salicylanilide.

### RELATED APPLICATION

This application is related to, and claims the benefit of, U.S. patent application Ser. No. 10/876,003 filed Feb. 13, 2003 entitled “Liquid Electrolyte For An Electrochemical Cell, Electrochemical Cell And Implantable Medical Device”, which is incorporated herein by reference in its entirety.

### FIELD OF THE INVENTION

The present invention generally relates to an electrochemical cell and, more particularly, to an additive in an electrolyte for a battery.

### BACKGROUND OF THE INVENTION

Implantable medical devices (IMDs) detect, diagnose, and deliver therapy for a variety of medical conditions in patients. IMDs include implantable pulse generators (IPGs) or implantable cardioverter-defibrillators (ICDs) that deliver electrical stimuli to tissue of a patient. ICDs typically comprise, inter alia, a control module, a capacitor, and a battery that are housed in a hermetically sealed container. When therapy is required by a patient, the control module signals the battery to charge the capacitor, which in turn discharges electrical stimuli to tissue of a patient.

The battery includes a case, a liner, and an electrode assembly. The liner surrounds the electrode assembly to prevent the electrode assembly from contacting the inside of the case. The electrode assembly comprises an anode and a cathode with a separator therebetween. In the case wall or cover is a fill port or tube that allows introduction of electrolyte into the case. The electrolyte is a medium that facilitates ionic transport and forms a conductive pathway between the anode and cathode. An electrochemical reaction between the electrodes and the electrolyte causes charge to be stored on each electrode. The electrochemical reaction also creates a solid electrolyte interphase (SEI) or passivation film on a surface of an anode such as a lithium anode. The passivation film is ionically conductive and prevents parasitic loss of lithium. However, the passivation film increases internal resistance which reduces the power capability of the battery. It is desirable to reduce internal resistance associated with the passivation film for a battery.

### BRIEF DESCRIPTION OF THE DRAWINGS

The present invention will become more fully understood from the detailed description and the accompanying drawings, wherein:

FIG. 1 is a cutaway perspective view of an implantable medical device (IMD);

FIG. 2 is a cutaway perspective view of a battery in the IMD of FIG. 1;

FIG. 3 is an enlarged view of a portion of the battery depicted in FIG. 2 and designated by line 4.

FIG. 4 is a cross-sectional view of an anode and a passivation film;

FIG. 5 is graph that compares performance between a conventional battery cell and exemplary battery cell that includes an additive to an electrolyte;

FIG. 6A is a lithium anode from a control cell after one month of storage at 60° C.;

FIG. 6B is a lithium anode from a cell containing an additive after one month of storage at 60° C.; and

FIG. 7 is a flow diagram for forming an electrolyte in a battery.

### DETAILED DESCRIPTION

The following description of embodiments is merely exemplary in nature and is in no way intended to limit the invention, its application, or uses. For purposes of clarity, the same reference numbers are used in the drawings to identify similar elements.

The present invention is directed to an organic additive for an electrolyte in lithium carbon monofluoride silver vanadium oxide (Li/CFx-SVO) batteries. The additive stabilizes performance of the battery during storage, thermal processing, and throughout discharge. In one embodiment, the organic additive is characterized by a hydroxy (—OH) and/or carboxy groups. Exemplary additives include lithium salicylate, hydroxyphthalic anhydride, a hydroxybenzoic acid, salicylate ester, salicylamide, and salicylanilide. These additives enable batteries to exceed certain performance and stability requirements.

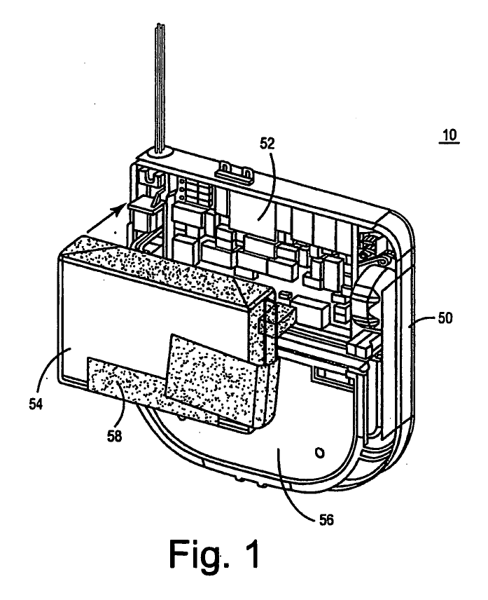

FIG. 1 depicts an implantable medical device (IMD) 10 such as implantable cardioverter-defibrillators. IMD 10 includes a case 50, a control module 52, a battery 54 (e.g. organic electrolyte battery) and capacitor(s) 56. Control module 52 controls one or more sensing and/or stimulation processes from IMD 10 via leads (not shown). Battery 54 includes an insulator 58 disposed therearound. Battery 54 charges capacitor(s) 56 and powers control module 52.

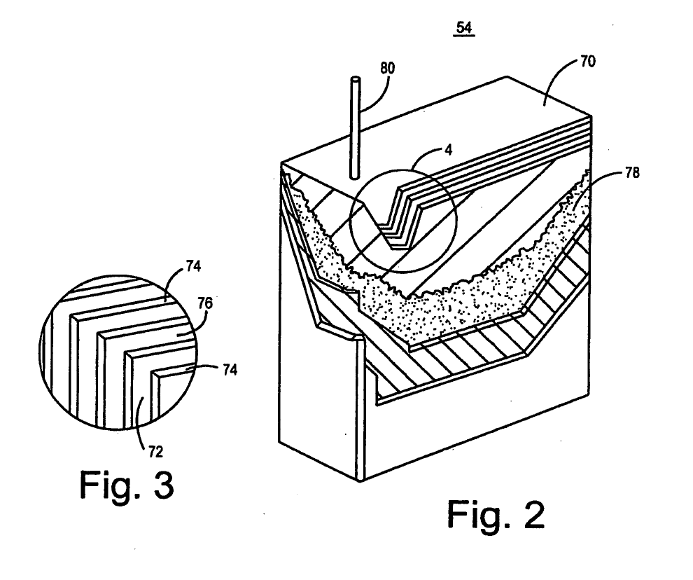

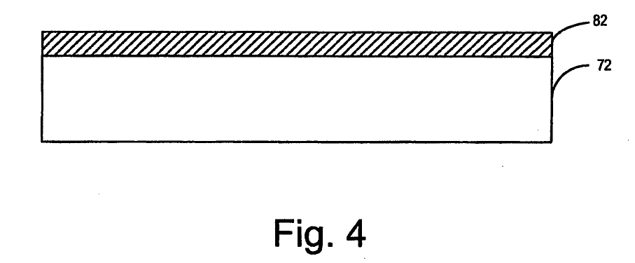

FIGS. 2 and 3 depict details of an exemplary organic electrolyte battery 54. Battery 54 includes a case 70, an anode 72, separators 74, a cathode 76, a liquid electrolyte 78, and a feed-through terminal 80. Cathode 76 is wound in a plurality of turns, with anode 72 interposed between the turns of the cathode winding. Separator 74 insulates anode 72 from cathode 76 windings. Case 70 contains the liquid electrolyte 78 to create an ionically conductive path between anode 72 and cathode 76. Electrolyte 78, which includes an additive, serves as a medium for migration of ions between anode 72 and cathode 76 during an electrochemical reaction with these electrodes. Electrolyte 78 includes, for example, LiPF₆ in propylene carbonate (PC) and dimethoxyethane (DME).

Anode 72 is formed of a material selected from Group IA, IIA or IIIB of the periodic table of elements (e.g. lithium, sodium, potassium, etc.), alloys thereof or intermetallic compounds (e.g. Li—Si, Li—B, Li—Si—B etc.). Anode 72 comprises an alkali metal (e.g. lithium, etc.) in metallic or ionic form. Cathode 76 may comprise metal oxides (e.g. vanadium oxide, silver vanadium oxide (SVO), manganese dioxide (MnO₂), lithium vanadium oxide (LiV3O8) etc.), carbon monofluoride and hybrids thereof (e.g., CFₓ+MnO₂), combination silver vanadium oxide (CSVO) or other suitable compounds.

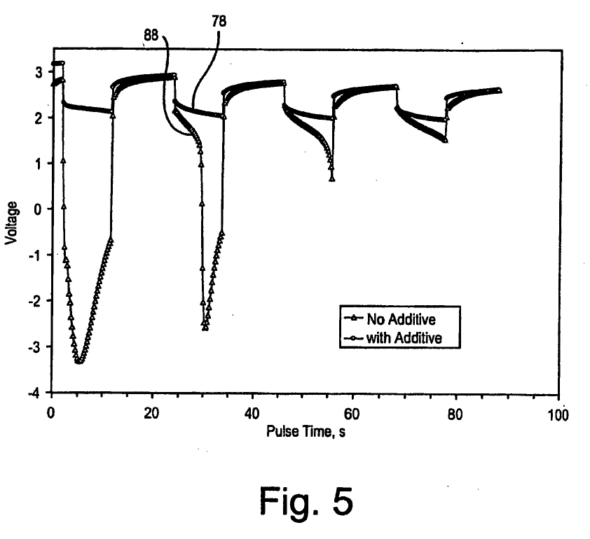

Electrolyte 78 chemically reacts with anode 72 to form an ionically conductive passivation film 82 on anode 72, as shown in FIG. 4. Electrolyte 78 includes a base liquid electrolyte composition and at least one performance enhancing additive selected from Table 1 presented below. In another embodiment, electrolyte 78 includes a base liquid electrolyte composition and at least one performance enhancing additive selected from Table 2. The base electrolyte composition typically comprises 1.0 molar (M) lithium hexafluorophosphate (1-20% by weight), propylene carbonate (40-70% by weight), and 1,2-dimethoxyethane (30-50% by weight). A small amount (e.g. 0.05 M) of organic additive is combined with electrolyte 78.

TABLE 1
List of exemplary organic additives

| Exemplary additive compound | |
|---|---|
| (Chemical Name) | Chemical Structure |
| Lithium salicylate | 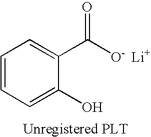 |
| Ethyl salicylate | 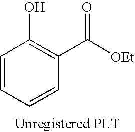 |
| 4-Hydroxy benzoic acid | 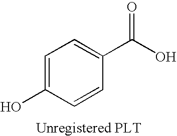 |
| 4-Hydroxy benzamide | 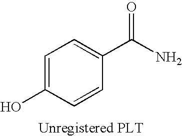 |
| 3-Hydroxy benzoic acid | 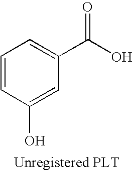 |
| 2-Hydroxy phthalic anhydride | 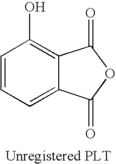 |
| 2-Hydroxy phthalic amide | 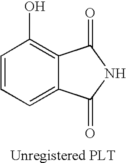 |
| 2-Hydroxy phthalic acid | 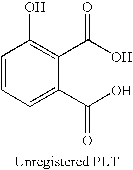 |
| 2-Hydroxy benzoic acid | 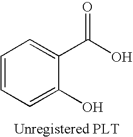 |
| Salicyl anilide | 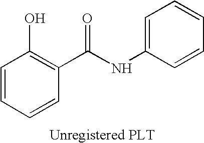 |

Skilled artisans understand that additive compositions may be mixed with the base electrolyte composition to increase performance of battery 54. Additive compositions are formed by selecting at least two additives from Table 1 and/or Table 2. Effective additive compositions are based upon additives that exhibit superior performance stabilizing characteristics of battery 54. Generally, each additive is combined with electrolyte 78 through dissolution or other suitable means.

The additives are based upon a chemical class referred to as aromatic hydroxcarboxylates. There are two base compounds that form the performance enhancing additives. The chemical structure for the first base compound is as follows:

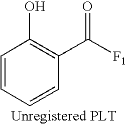

where F1 represents a first group such as a hydroxy group (OH).
The chemical structure for the second base compound is as follows:

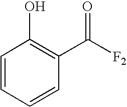

where F2 represents a second group. The second group comprises ZA. Z is defined as O, N, B, P, Si. A is defined as M, H, R where M represents metals such as Li, Na, K and other suitable metals.

The present invention also includes derivatives of the first or second base compounds. For example, one or more carboxy groups may be added to one of the base compounds. Additionally, one or more hydroxy groups may be added to one of the base compounds. Furthermore, a combination of at least one or more carboxy groups and at least one or more hydroxy groups may be added to one of the base compounds. Still yet another derivative relates to condensation products. Bis-(3-hydroxy benzoic anhydride) is an exemplary condensation product.

Table 2 lists exemplary embodiments in which the position of each group, represented by F1 and F2, are placed in different positions relative to the carbon atom of a benzene compound. A benzene compound includes six carbon atoms that are represented by the symbols C1, C2, C3, C4, C5, and C6, as shown below:

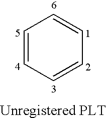

Skilled artisans understand that a variety of other combinations exist in which F1 and F2 are repositioned. Table 2 may be interpreted in at least two ways. First, a skilled artisan selects a compound such as compound 1. For compound 1, F1 is located at C6 and F2 is located at C1. Alternatively, a skilled artisan may select the position of F1 and F2 to determine the type of compound.

TABLE 2
Exemplary performance enhancing additives in which groups
F1 and F2 change their positions along a benzene ring

| | | C1 | C2 | C3 | C4 | C5 | C6 |
|---|---|---|---|---|---|---|---|
| Compound | | atom | atom | atom | atom | atom | atom |
| 1 | F1 | 0 | 0 | 0 | 0 | 0 | 1 |
| 2 | F1 | 0 | 0 | 0 | 0 | 1 | 0 |
| 3 | F1 | 0 | 0 | 0 | 1 | 0 | 0 |
| 4 | F1 | 0 | 0 | 1 | 0 | 0 | 0 |
| 5 | F1 | 0 | 1 | 0 | 0 | 0 | 1 |
| 6 | F1 | 1 | 0 | 0 | 0 | 0 | 0 |
| 1 | F2 | 1 | 0 | 0 | 0 | 0 | 0 |
| 2 | F2 | 0 | 1 | 0 | 0 | 0 | 0 |
| 3 | F2 | 0 | 0 | 1 | 0 | 0 | 0 |
| 4 | F2 | 0 | 0 | 0 | 1 | 0 | 0 |
| 5 | F2 | 0 | 0 | 0 | 0 | 1 | 0 |
| 6 | F2 | 0 | 0 | 0 | 0 | 0 | 1 |

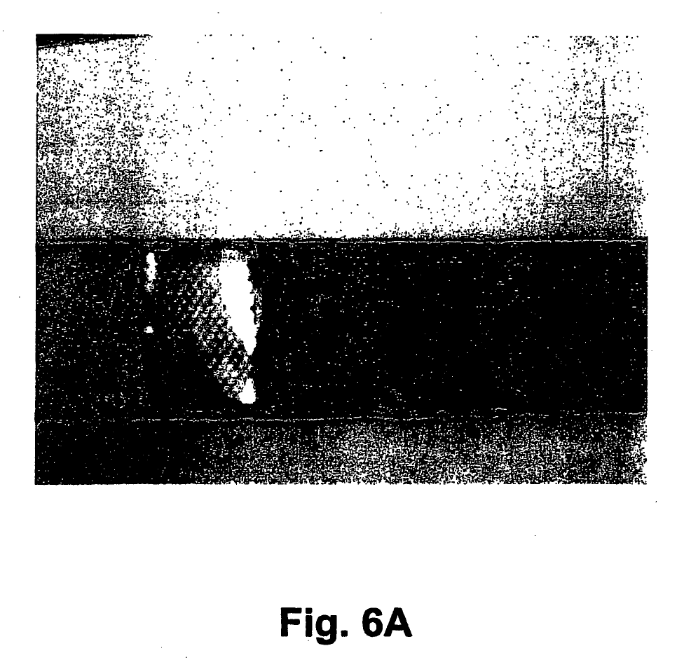

FIG. 5 graphically depicts the superiority of electrolyte 78 over a control electrolyte 88. Electrolyte 78 includes lithium salicylate as the organic additive and the base electrolyte composition previously described. Control electrolyte 88 is the base electrolyte composition without any additive. Passivation layer 82 initially possesses similar discharge to passivation layer formed by control electrolyte 88. However, beginning in the discharge (BOL), the passivation layer formed by control electrolyte 88 exhibits resistance that substantially increases. In contrast, electrolyte 78 that includes the additive causes battery 54 to exhibit increased performance and resistance that remains substantially below the resistance of control electrolyte 88 late in discharge. For example, electrolyte 78 results in battery 54 having 30 ohms lower resistance than control electrolyte 88, as show in FIG. 5.

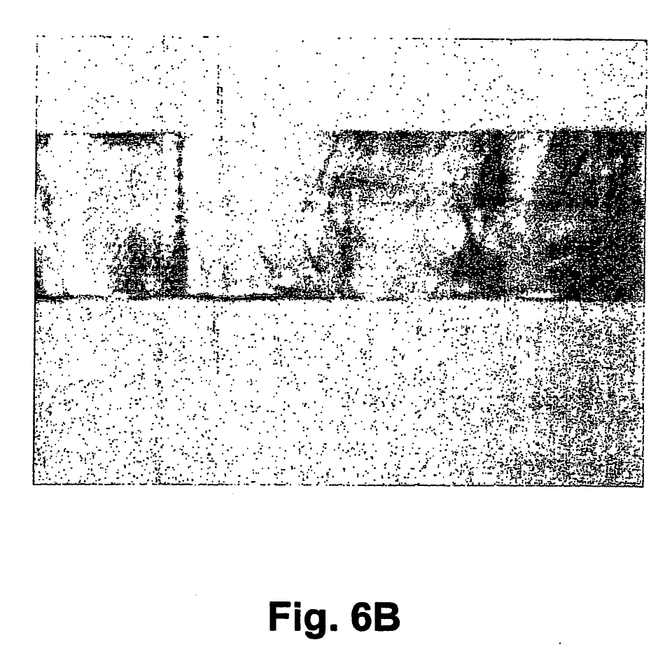

FIGS. 6A-6B illustrate the significant difference between a lithium anode of a control battery cell 100 to a lithium anode from a battery cell 110 containing an additive after one month of storage at 60° C. Lithium anode 110 with the additive is a lighter shade of gray than the lithium anode 100 of a control battery cell. A lighter shade indicates less oxidation occurred which, in turn, produces a decreased amount of a passivation layer 82 compared to a conventional lithium anode 100.

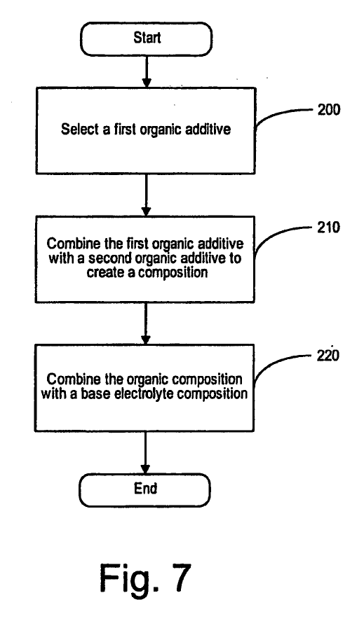

FIG. 7 depicts a method for forming an organic additive composition, which is later added to an electrolyte composition. At operation 200, a first organic additive is selected. At operation 210, the first organic additive is combined with a second organic additive to create an organic additive composition.

The following patent application is incorporated by reference in its entirety. Co-pending U.S. patent application Ser. No. ______, entitled “RESISTANCE-STABILIZING ADDITIVES FOR ELECTROLYTE”, filed on Jan. 31, 2006 by Donald Merritt and Craig Schmidt and assigned to the same Assignee of the present invention, describes resistance-stabilizing additives for electrolyte. Although various embodiments of the invention have been described and illustrated with reference to specific embodiments thereof, it is not intended that the invention be limited to such illustrative embodiments. For example, while an additive composition is described as a combination of two additives, it may also include two or more additives selected from Table 1. The description of the invention is merely exemplary in nature and, thus, variations that do not depart from the gist of the invention are intended to be within the scope of the invention. Such variations are not to be regarded as a departure from the spirit and scope of the invention.

1-8. (canceled)

9. An implantable medical device comprising a battery comprising an electrode assembly and an electrolyte, wherein the electrolyte comprises a liquid electrolyte and a performance enhancing additive, wherein the performance enhancing additive comprises an organic compound comprising hydroxy and carboxy groups.

10. The implantable medical device of claim 9 wherein the electrode assembly comprises an anode comprising an element selected from the group of a Group IA element and a Group IIA element.

11. The implantable medical device of claim 10 wherein the anode comprises material selected from the group of a Group IA metal, an alloy thereof, and an intermetallic compound thereof.

12. The implantable medical device of claim 11 wherein the anode comprises a Group IA element in metallic form.

13. The implantable medical device of claim 11 wherein the anode comprises a Group IA element in ionic form.

14. The implantable medical device of claim 10 wherein the electrode assembly comprises a lithium anode.

15. The implantable medical device of claim 9 wherein the liquid electrolyte comprises a lithium salt, propylene carbonate, and dimethoxyethane.

16. The implantable medical device of claim 9 wherein the electrode assembly comprises a cathode comprising a metal oxide.

17. The implantable medical device of claim 16 wherein the cathode comprises a metal oxide selected from the group of vanadium oxide, silver vanadium oxide, manganese oxide, and lithium vanadium oxide.

18. The implantable medical device of claim 9 wherein the electrode assembly comprises a cathode comprising carbon monofluoride and a hybrid thereof.

19. The implantable medical device of claim 9 wherein the battery is a lithium carbon monofluoride silver vanadium oxide (Li/CFx-SVO) battery.

20. The implantable medical device of claim 9 wherein the organic compound comprises an aromatic hydroxycarboxylate-based compound.

21. The implantable medical device of claim 20 wherein the hydroxycarboxylate-based compound is selected from the group consisting of lithium salicylate, ethyl salicylate, a hydroxyphthalic anhydride, a hydroxyphthalic acid, a hydroxyphthalic amide, a hydroxybenzoic acid, a hydroxybenzamide, salicylate ester, salicylamide, and salicylanilide.

22. The additive of claim 21 wherein the compound is selected from a group consisting of lithium salicylate, a hydroxyphthalic anhydride, a hydroxybenzoic acid, salicylate ester, salicylamide, and salicylanilide.

23. The implantable medical device of claim 9 wherein the organic compound has the following structure: 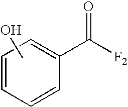
and derivatives thereof, wherein F₂ represents a ZA group, wherein Z is an atom selected from the group consisting of O, N, B, P, and Si, and A is an atom selected from the group consisting of M, H, and R, wherein M represents metals selected from the group consisting essentially of Li, Na, and K, and R is an organic group.

24. The implantable medical device of claim 23 wherein A is H.

25. The implantable medical device of claim 23 wherein A is M.

26. The implantable medical device of claim 9 wherein the performance enhancing additive comprises a mixture of different organic compounds comprising hydroxy and carboxy groups.

27. The implantable medical device of claim 26 wherein the performance enhancing additive comprises a first organic additive being at least one of lithium salicylate, a hydroxyphthalic anhydride, a hydroxybenzoic acid, salicylate ester, salicylamide, and salicylanilide.

28. The implantable medical device of claim 27 wherein the performance enhancing additive comprises a second organic additive being at least one of lithium salicylate, a hydroxyphthalic anhydride, a hydroxybenzoic acid, salicylate ester, salicylamide, and salicylanilide.

29. The implantable medical device of claim 28 wherein the performance enhancing additive comprises a third organic additive combined with the first and the second organic additives, the third organic additive being at least one of lithium salicylate, a hydroxyphthalic anhydride, a hydroxybenzoic acid, salicylate ester, salicylamide, and salicylanilide.

30. An implantable medical device comprising a battery comprising:
an electrode assembly comprising:
an anode comprising an element selected from the group of a Group IA element and a Group IIA element; and
a cathode comprising a metal oxide;
a liquid electrolyte comprising a performance enhancing additive, wherein the performance enhancing additive comprises at least one organic compound comprising hydroxy and carboxy groups.

31. An implantable medical device comprising a lithium carbon monofluoride silver vanadium oxide (Li/CFx-SVO) battery comprising a liquid electrolyte comprising a performance enhancing additive, wherein the performance enhancing additive comprises at least one aromatic hydroxycarboxylate-based compound.
